(19) United States
(12) Patent Application Publication
(10) Pub. No.: US 2012/0298698 A1
(43) Pub. Date: Nov. 29, 2012

(54) ADJUSTABLE DISPENSER

(76) Inventor: Sang Joon Lee, Seoul (KR)

(21) Appl. No.: 13/113,307

(22) Filed: May 23, 2011

(51) Int. Cl. G01F 11/00

(52) U.S. Cl. 222/309

(57) ABSTRACT

Provided is a dispenser for liquids having an adjustable dial that varies the stroke length of the pump to allow a user to change the dose per stroke.

### BACKGROUND OF THE INVENTION

Dispensers for viscous and non-viscous liquids are used in everyday life to dispense many different items, such as condiments (sauces, ketchups) or soap. These dispensers typically have a pump that a user strokes, and each stroke dispenses a particular dose of the liquid. A problem with these dispensers is that they do not allow a user to adjust the dose. This is useful for a number of reasons, including to control calories and sugar intake. This may be particularly useful for high calorie condiments, such as mayonnaise. Also, by way of example. for diabetics who need to accurately measure their sugar intake. Business owners may also find it useful to adjust the dispenser to control amounts used. For example, an owner of a business may want to adjust the amount of soap dispensed to control costs and limit over dispensing a large amount of soap (which would cost more money). Another advantage of the present invention is that it is useful for chefs, cooks and housewives as they can follow recipes without the need for a measuring spoon.

### SUMMARY OF THE INVENTION

In one embodiment, the present invention provides a dispenser for a viscous and non-viscous liquid comprising: a container having a discharge end for discharging a dose of the liquid and a pump for pumping the dose of the liquid out of the discharge end; an adjustable dial through which a portion of the pump extends out, said portion defining stroke length of the pump; wherein a user can adjust each dose of the liquid exiting the discharge end by adjusting the dial to vary the stroke length. The dispenser can further comprise a container having a discharge end for discharging a dose of the liquid and a pump for pumping the dose of the liquid out of the discharge end; an adjustable dial through which a portion of the pump extends out, said portion defining stroke length of the pump; wherein the discharge end and the container are in fluid communication with each other through the dial, with the inside portion of the stroke length of the pump having a channel to bring liquid to the discharge end, thereby having the stroke length of the pump having both the function of a channel for movement of the liquid and for generating force by being stroked. The dispenser can further comprise a nozzle attached to the end of the stroke length of the pump and in fluid communication with the channel of said stroke length, the nozzle providing a discharge end and increasing surface area for a user to stroke the pump. In one embodiment, the dispenser does not have any electrical components.

The dial can be made from plastic. In one embodiment, the dial comprises an outer cap and an inner cap slidably attached to each other, wherein the user can slide one cap in relation to the other to adjust the height of the dial. The outer cap can have one or more protrusions that slide through one or more channels of the inner cap, or vice versa. The number of protrusions and channels can be three. There can be sufficient friction between the inner and outer cap so that they slide against each other only when a force is applied by a user to adjust the dial. The dial can have grooves along the channels in which the protrusions fall into, thereby stopping the sliding movement. The dial with the channels can have grooves all along the channels with no spaces in between the grooves, in which grooves the protrusions fall into, thereby stopping the sliding movement all along the sliding path.

The container can have a volume of about 10 ounces to about 50 ounces based on weight of water. The liquid can be selected from the group consisting of a condiment, a sauce, ketchup, soap. The dial can be adjusted based on amount of an ingredient present in the liquid. The adjustment can be based on grams of sugar or salt. The stroke length can be adjusted to about or less than half of its maximal length.

In one embodiment the present invention provides a method of consuming a viscous or non-viscous liquid from a dispenser comprising: a) determining the amount of the liquid to be dispensed; b) adjusting the dial of the dispenser based on the determination in step a); c) pumping the liquid from the dispenser by pressing the stroke length portion of the pump against the dial.

In one embodiment the present invention provides method of consuming a condiment by a user who is diabetic comprising dispensing the condiment based on the grams of sugar present in the condiment with the dispenser.

### BRIEF DESCRIPTION OF THE FIGURES

FIG. 1 illustrates a sauce dispenser with a container (1), an adjustable dial (2) with the height of the dial represented by a line (4), a pump stroke length (3), a nozzle (6), a discharge end (7), and a dose amount indicator (5).

FIG. 2 illustrates the pump stroke length at its maximum (3) which is then reduced by adjusting the dial (2A and 2B). This figure illustrates the change in stroke length when the dial is turned for different dispensing options. When the dial is turned up, the stroke length decreases, yielding less sauce, and on the other hand, when the dial is turned down, the stroke length increases, giving more sauce.

FIG. 3 illustrates the inner cap (2B) and its opening (9) through which the pump stroke length travels; the inner cap has three channels (10) and three grooves (11).

FIG. 4 illustrates the outer cap (2A) with a protrusion (12) that slides in the channels of the inner cap as shown in FIG. 3.

FIG. 5 is a planar figure illustrating the inner cap cut open and laid flat, and the inner wall of the outer cap. FIG. 6 depicts the conventional way in the left box, and the right box is using the adjustable dispenser.

### DETAILED DESCRIPTION OF THE INVENTION

The present invention provides a dispenser where each dose that is dispensed can be adjusted by a user. The adjustable dispenser has a controllable dial on the body of the pump cap. By turning the pump cap, the amount of sauce per pump can be adjusted, such as per serving size, per gram, per ounce, per 1 tablespoon and/or 1 teaspoon depending on the type and use of the liquid. The amount of liquid (such as sauce) dispensed depends on the capacity of the chamber, but also on the length of the pumping stroke, which is set by the dial. The dispenser can adjust the dose without the need for electrical components.

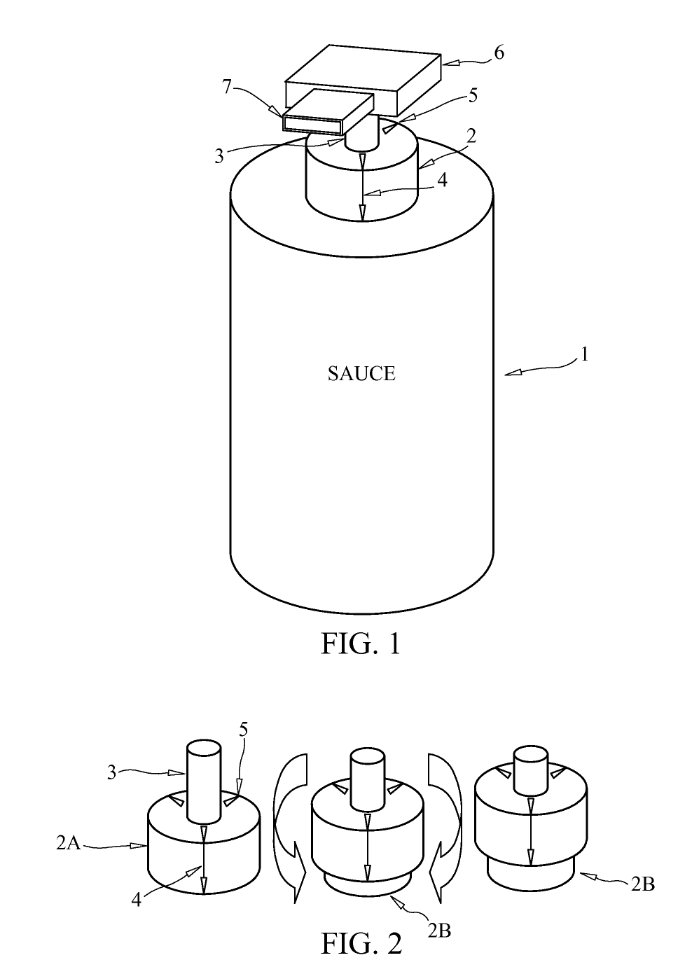

As shown in FIGS. 1-5, the dispenser comprises a container (1) having a discharge end (7) for discharging a dose of the liquid and a pump for pumping the dose of the liquid out of the discharge end (7). The dispenser has an adjustable dial (2) through which a portion of the pump (3) extends out. This portion of the pump (3) defined the stroke length of the pump as the stroke length correlates to the amount of each dose. A user can adjust each dose of the liquid exiting the discharge end (7) by adjusting the dial (2) to vary the stroke length.

FIG. 1 illustrates a sauce dispenser. The container (1) holds a sauce or could alternatively hold another condiment. An adjustable dial (2) is put on the body of the pump above the container (1). The height of the dial represented by a line (4) can be adjusted by rotating the dial. The height of the dial may be represented by a line, dot, mark or any design that indicates the current setting. In this way, the design can be fully customized according to the user's needs and purposes. A portion of the pump that defines the stroke length (3) extends out of the dial (2). A nozzle (6) is put at end of the stroke length (2) of the pump. The stroke length of the pump (3) has a channel inside that is in fluid communication with the nozzle (6). The nozzle has a discharge end (7) where the sauce exits the container. The dial (2) has a dose amount indicator (5) that indicates the setting for the dose to be dispensed.

In one embodiment, the discharge end (7) and the container (1) are in fluid communication with each other through the dial (2), with the inside portion of the stroke length of the pump (2) having a channel to bring liquid to the discharge end, thereby having the stroke length of the pump having both the function of a channel for movement of the liquid and for generating force by being stroked.

The dispenser can further comprise a nozzle (6) attached to the end of the stroke length of the pump (3) and in fluid communication with the channel of said stroke length, the nozzle providing a discharge end (7) and increasing surface area for a user to stroke the pump. This embodiment is illustrated in FIG. 1 where the nozzle (6) is attached to the end of the stroke length (3) of the pump.

The dial is preferably a rotatable knob with a height that can be adjusted through rotating the dial with a hand. In theory the dial can be any bulky object whose height can be adjusted so as to vary the stroke length. The dial (2) can be made from different materials, such as metal or plastic. In one embodiment, the dial comprises an outer cap (2A) and an inner cap (2B) slidably attached to each other, wherein a user can slide one cap in relation to the other to adjust the height of the dial. The sliding allows for rotating the cap in relation to the inner cap. The outer cap can have one or more protrusions (12) that slide through one or more channels (10) of the inner cap, or vice versa. In one embodiment, the number of protrusions and channels is three.

FIG. 2 illustrates the rotation of the dial to vary the stroke length. In a first position with the stroke length (3) at tis maximum, the height of the dial is shown by line (4). The outer cap (2A) is visible but the inner cap (2B) is not. The outer dial is then rotated in relation to the inner dial (2B). The inner dial (2B) comes out and makes the dial taller. As a result, the stroke length (3) is now shorter.

Different mechanisms can be used to adjust the height of the dial. The inner and outer caps can be designed so there is sufficient friction between the inner and outer cap so that they slide against each other only when a force is applied by a user to adjust the dial. Alternatively, the dial with the channels can have grooves (11) along the channels in which the protrusions fall into, thereby stopping the sliding movement. These grooves can also be put all along the channels with no spaces in between the grooves, in which grooves the protrusions fall into, thereby stopping the sliding movement all along the sliding path.

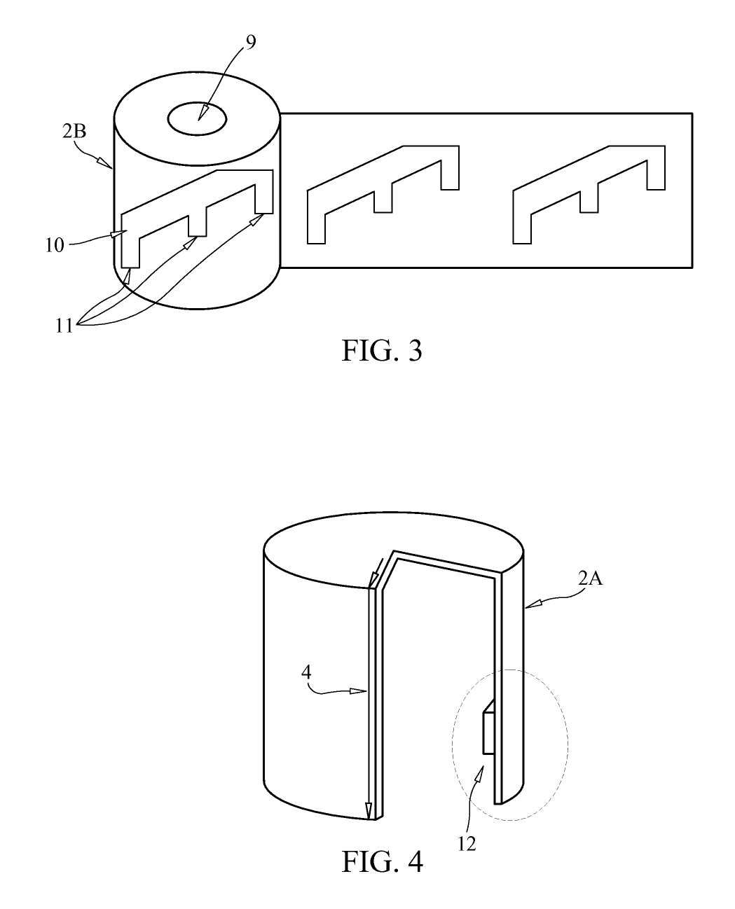

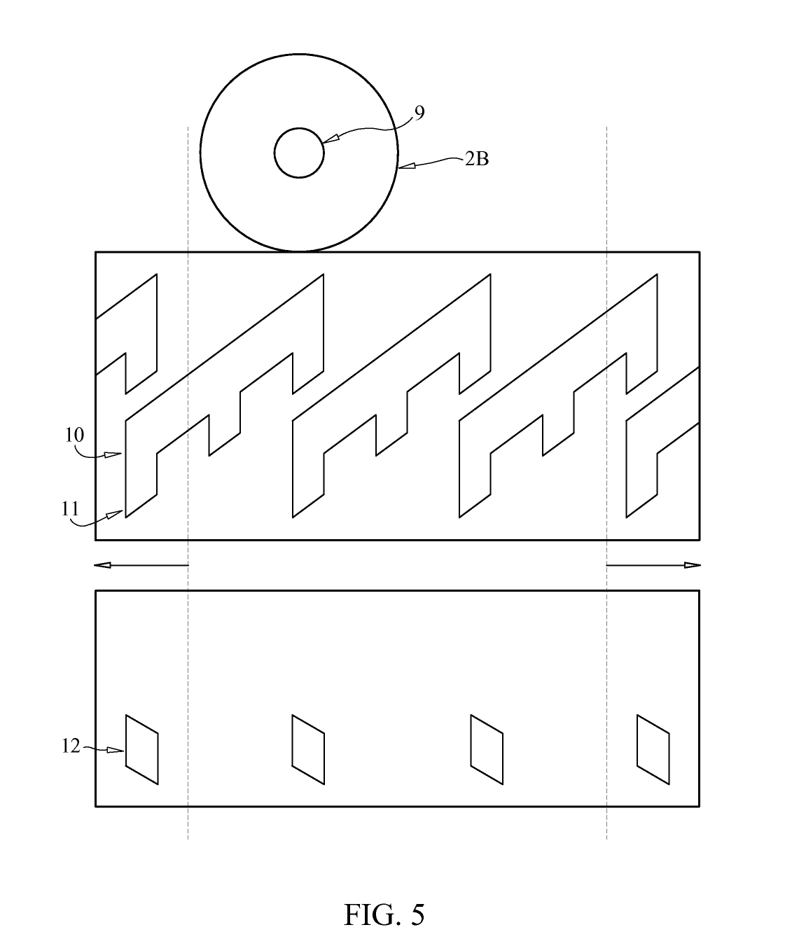

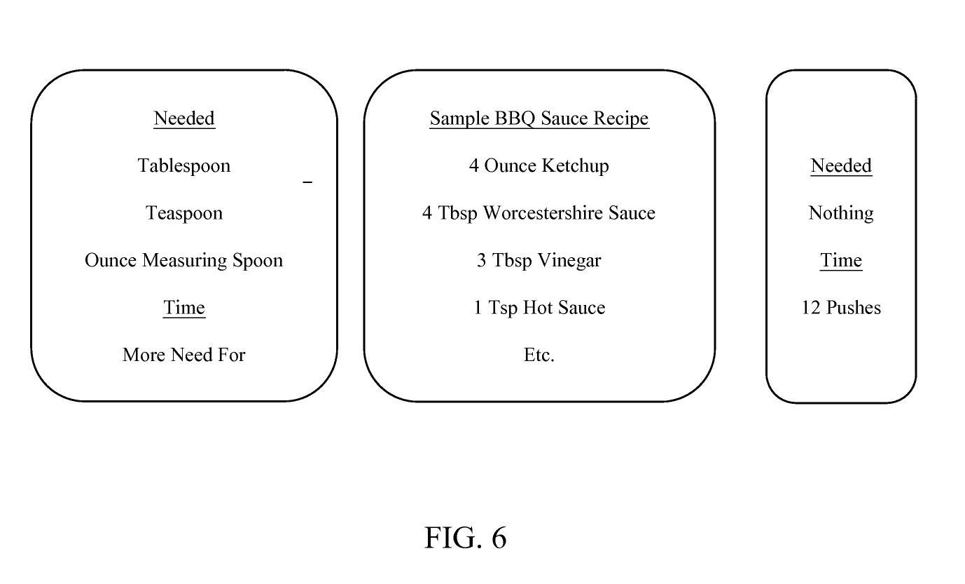

FIGS. 3 and 4 show the detailes of the inner and outer caps. In FIG. 3, the inner cap (2B) is shown with three channels (10) on the outside of the inner cap. The channels have grooves (11). The inside of the inner cap has an opening (9) through which the storke length (3) of the pump is inserted and the liquid is moved. Figure shows the outer cap (2A) with a protrusion (12) that slide in the channels of the inner cap. The protrusion also is of such a size that can fall in the grooves (11) to immobilize the dial.

The container (1) can have a volume of about 10 ounces to about 50 ounces based on weight of water. The liquid in the container can be viscous or non-viscous, and can be one or more of condiment, a sauce, ketchup, and soap.

FIG. 5 is a planar figure illustrating the inner cap cut open and laid flat, and the inner wall of the outer cap. This is the inner cap (2B). The rectangle on the left (20) would be the outer wall of the inner cap. The inner cap has three identical carved-in gated paths or channels (10), They guide the plastic piece on the inner wall of the outer cap, which may be along. If one were to cut this figure out and paste them to reconstruct the inner cap, the arrowed part after the thick dotted line is where they overlap (where you would glue them together). And this would be the inner wall of the outer cap spread out and laid flat. The inner wall has three pieces, that may be made of plastic, and that may stick out to fit into the gated path of the inner cap. They move along the gated path and as they are attached to the outer cap, moves the outer cap upward/downward to adjust the stroke of the pump.

In one embodiment, the dial is adjusted based on amount of an ingredient present in the liquid, such as, based on grams of sugar or salt. For example, ketchup has 3-4 grams of sugar per tablespoon. A ketchup dispenser would be made where each point of adjustment for the dial (5) is based on one gram of sugar, so a user can choose between a dose of ketchup having one, two, three, four or five grams of sugar. Alternatively, the dial can be set based on the amount of per serving indicated on the dispenser. For example, the amount of serving for ketchup is about one tablespoon, and the dispenser can be made so that each dose indicator (5) is based on the per serving amount.

A user who uses the dispenser would determine the amount of the liquid to be dispensed and then adjust the dial of the dispenser based on such determination. The user would then pump the liquid from the dispenser by pressing the stroke length portion of the pump against the dial.

Each dose (per single push) can be set to different options, such as 1: 1 Oz/Option 2: 1 Tbsp/Option 3: 1 Tsp/Option 4: serving size. The serving size option, which dispenses the single serving amount of the according sauce makes it easier to track calories coming from sauces, as one pump indicates the calorie written on the nutritional facts on the package. This makes cooking convenient, Since one can directly pump 1 Tbsp from the dispenser, a user no more have to look for tablespoon/teaspoon and also takes out the frustration of whether the spoon is using is the right size.

FIG. 6 is the sample comparison of following a recipe. Left box is the conventional way, and the right box is using the adjustable dispenser.

It should be understood that the foregoing relates to preferred embodiments of the invention and that modifications may be made without departing from the spirit and scope of the invention as set forth in the following claims.

What is claimed is:

1. A dispenser for a viscous and non-viscous liquid comprising:
a container having a discharge end for discharging a dose of the liquid and a pump for pumping the dose of the liquid out of the discharge end;
an adjustable dial through which a portion of the pump extends out, said portion defining stroke length of the pump;
wherein a user can adjust each dose of the liquid exiting the discharge end by adjusting the dial to vary the stroke length.

2. The dispenser of claim 1, the dispenser further comprising the discharge end and the container in fluid communication with each other through the dial, with the inside portion of the stroke length of the pump having a channel to bring liquid to the discharge end, thereby having the stroke length of the pump having both the function of a channel for movement of the liquid and for generating force by being stroked.

3. The dispenser of claim 2, the dispenser further comprising a nozzle attached to the end of the stroke length of the pump and in fluid communication with the channel of said stroke length, the nozzle providing a discharge end and increasing surface area for a user to stroke the pump.

4. The dispenser of claim 1, wherein the dispenser does not have any electrical components.

5. The dispenser of claim 1, wherein the dial is made from plastic.

6. The dispenser of claim 1, wherein the dial comprises an outer cap and an inner cap slidably attached to each other, wherein the user can slide one cap in relation to the other to adjust the height of the dial.

7. The dispenser of claim 6, wherein the outer cap has one or more protrusions that slide through one or more channels of the inner cap, or vice versa.

8. The dispenser of claim 7, wherein the number of protrusions and channels is three.

9. The dispenser of claim 6, wherein there is sufficient friction between the inner and outer cap so that they slide against each other only when a force is applied by a user to adjust the dial.

10. The dispenser of claim 7, wherein the dial with the channels has grooves along the channels in which the protrusions fall into, thereby stopping the sliding movement.

11. The dispenser of claim 7, wherein the dial with the channels has grooves all along the channels with no spaces in between the grooves, in which grooves the protrusions fall into, thereby stopping the sliding movement all along the sliding path.

12. The dispenser of claim 1, wherein the container has a volume of about 10 ounces to about 50 ounces based on weight of water.

13. The dispenser of claim 1, wherein the liquid is selected from the group consisting of a condiment, a sauce, ketchup, soap

14. The dispenser of claim 1, wherein the dial is adjusted based on amount of an ingredient present in the liquid.

15. The dispenser of claim 14, wherein the adjustment is based on grams of sugar or salt.

16. The dispenser of claim 1, wherein the stroke length can be adjusted to about or less than half of its maximal length.

17. A method of consuming a viscous or non-viscous liquid from a dispenser comprising:
a) determining the amount of the liquid to be dispensed;
b) adjusting the dial of the dispenser of claim 1 based on the determination in step a);
c) pumping the liquid from the dispenser by pressing the stroke length portion of the pump against the dial.

18. A method of consuming a condiment by a user who is diabetic comprising dispensing the condiment based on the grams of sugar present in the condiment with the dispenser of claim 1.
